(19) United States
(12) Patent Application Publication
(10) Pub. No.: US 2026/0105506 A1
(43) Pub. Date: Apr. 16, 2026

(54) OPTIMIZED CO-HOST RANKING SYSTEM

(71) Applicant: Airbnb, Inc., San Francisco, CA (US)

(72) Inventors: Waruntorn Zhang, San Francisco, CA (US); Xueme Qiu, Fremont, CA (US); Yuning Liao, San Mateo, CA (US); Mary Feng, San Mateo, CA (US); Pablo Flouret Columba, New York, NY (US); Jialie Hu, Milpitas, CA (US); Sushu Zhang, Palo Alto, CA (US); Pratik Sanjay Tandel, San Francisco, CA (US)

(21) Appl. No.: 19/358,050

(22) Filed: Oct. 14, 2025

Related U.S. Application Data
(60) Provisional application No. 63/707,089, filed on Oct. 14, 2024.

(51) Int. Cl. G06Q 30/0601; G06Q 50/16

(52) U.S. Cl. CPC G06Q 30/0629; G06Q 30/0641; G06Q 50/16

(57) ABSTRACT

Systems and methods are provided for providing, in real time, a ranked list of candidate co-hosts to the computing device based on a final ranking score for each candidate co-host. For example, the systems and methods use a trained machine learning model configured to generate a relevance score for each of a plurality of candidate co-hosts and generate a co-host activation rate for each candidate co-host. The systems and methods generate for each co-host candidate, a normalized relevance score for a respective relevance score using a normalization function, and an activation probability based on the co-host activation rate for each co-host candidate. The systems and methods generate a final ranking score for each co-host candidate based on the normalized relevance score and the activation probability for each co-host candidate.

### PRIORITY

This application claims the benefit of priority to U.S. Provisional Application Ser. No. 63/707,089, filed Oct. 14, 2024, which is incorporated by reference herein in its entirety.

### BACKGROUND

An online marketplace may provide a number of services, such as accommodations, tours, transportation and the like, and allow users to reserve or “book” one or more services. For example, a first user (e.g., host) can list one or more services on the online marketplace and a second user (e.g., guest) can request to view listings of services for a particular location (e.g., San Francisco) that may include a listing for the first user's service.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some examples.

FIG. 2 is a block diagram illustrating a reservation system, according to some examples.

FIG. 3 illustrates an example user interface for a description of a listing for a trip item, according to some examples.

FIG. 4 is a block diagram with further details of an optimized ranking system, according to some examples.

FIG. 5 is a flow chart illustrating aspects of a method, according to some examples.

FIG. 6 is an example of a ranked list of co-hosts, according to some examples.

FIG. 7 is an example user interface, according to some examples.

FIG. 8 diagrammatically illustrates a machine learning pipeline, according to some examples.

FIG. 9 is a block diagram illustrating an example of a software architecture that may be installed on a machine, according to some examples.

FIG. 10 illustrates a diagrammatic representation of a machine, in the form of a computer system, within which a set of instructions may be executed for causing the machine to perform any one or more of the methodologies discussed herein, according to some examples.

### DETAILED DESCRIPTION

Systems and methods described herein relate to an optimized ranking system. As mentioned above, a host can list one or more services in an online marketplace. These services or listings can comprise accommodations, experiences, or other services. Hosting services can be a rewarding experience, but it can become overwhelming for hosts to manage. A co-host can assist with hosting routines, such as setting up a listing, messaging guests, cleaning, and so forth. Co-hosting reduces hosting responsibilities, drives economic growth for both hosts and co-hosts, and can provide for a better experience for guests of the listings.

One technical problem is how to match co-hosts with hosts, and in a real-time or near real time response time from receiving a request for a co-host in the online marketplace. There can be hundreds of thousands or millions of hosts in an online marketplace, all with very unique listings and needs. Further, there can be more than hundreds or thousands of co-hosts available to assist hosts. Also, the number of hosts and co-hosts continues to grow. Moreover, a host may not know what they want or what services are available when looking for a co-host. Additionally, it is technically difficult to determine unique and specific qualities associated with each host and co-host since each listing is different and each co-host has different expertise and experience level.

One simple way of matching co-hosts to a host is to use heuristics such as an average rating of a co-host, a connection rate (how many hosts the co-host connects with to discuss potentially co-hosting) or an activation rate (how many hosts the co-host activates a partnership with to co-host one or more listings for the host). However, this method does not take into account the unique features of a listing, the specific needs of a host or the specific expertise and experience level of each co-host. Further, this limits the flexibility to adapt to changing host or co-host characteristics or behaviors. This method can further introduce human biases or subjectivity in pre-defined rules.

Accordingly, an optimized ranking system is described herein that is a dynamic, scalable and personalized solution to match co-hosts with a host by utilizing a machine learning model to analyze a significant number of features (e.g., 75-100+) to generate a relevance score to combine with co-host activation heuristics to generate a final ranking score for candidate co-hosts for a given host. The optimized ranking system prioritizes more relevant co-hosts using various signals from a search query entered by a host (e.g., a request for a co-host in a given location), host and listing features (e.g., host tenure, listing type, number of bedrooms), and co-host features (e.g., proximity to listing, average overall rating, services offered) by analyzing these features using the machine learning model. Further, the optimized ranking system uses co-host activation heuristics based on the historical activation rate of each co-host (e.g., number of hosts activated/number of hosts connected) to prioritize co-hosts who have previously activated partnerships with hosts. The activation rate is used in combination with the relevance score generated by the machine learning model to compute a final ranking score for each candidate co-host. In this way, the optimized ranking system provides an improved way to match co-hosts with a host based on the quality, the services provided and the service area of a co-host that also encourages a variety of co-hosts to result in more relevant co-hosts personalized for a given host.

For example, the optimized ranking system provides, in real time, a ranked list of candidate co-hosts to a computing device based on a final ranking score for each candidate co-host. For instance, the optimized ranking system determines candidate co-hosts from a plurality of co-hosts based on parameters in the co-host search query. The optimized ranking system, using a trained machine learning model configured to generate a relevance score for each of a plurality of candidate co-hosts, analyzes the co-host search query, characteristics associated with the host, listing features for listings associated with the host, and co-host features associated with each candidate co-host to generate a relevance score for each candidate co-host. The optimized ranking system generates a co-host activation rate for each candidate co-host based on a number of hosts each candidate co-host has connected with and a number of hosts each candidate co-host has activated. The optimized ranking system further generates, for each co-host candidate, a normalized relevance score for a respective relevance score using a normalization function and an activation probability based on the co-host activation rate for each co-host candidate. The optimized ranking system generates a final ranking score for each co-host candidate based on the normalized relevance score and the activation probability for each co-host candidate.

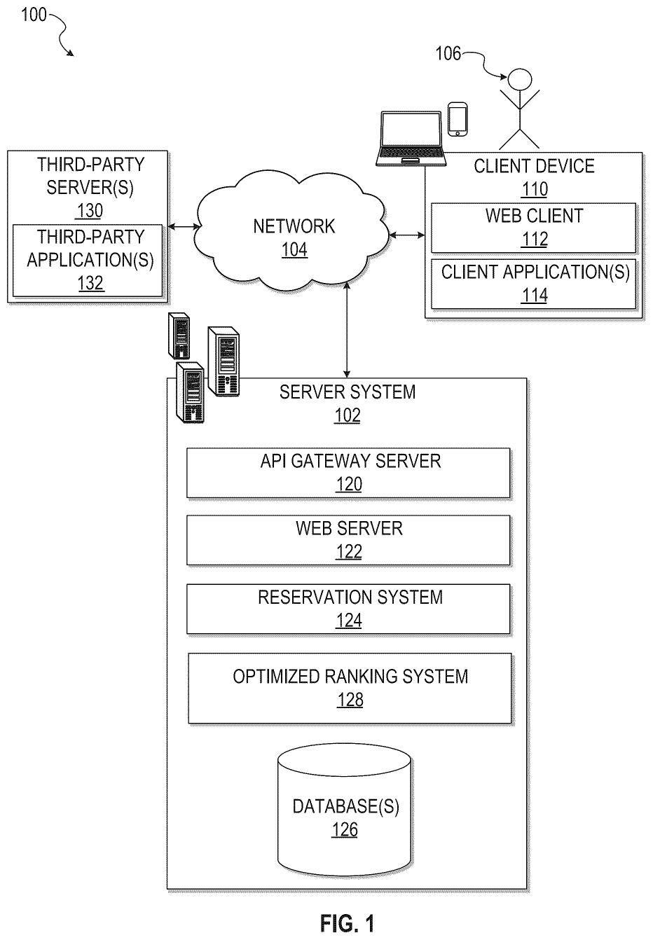

FIG. 1 is a block diagram illustrating a networked system 100, according to some example embodiments. The networked system 100 can include one or more computing devices such as a client device 110. The client device 110 may comprise, but is not limited to a mobile phone, desktop computer, laptop, portable digital assistant (PDA), smart phone, tablet, ultrabook, netbook, laptop, multiprocessor system, microprocessor-based or programmable consumer electronic system, game console, set-top box, computer in a vehicle, wearable device (e.g., smart watch, smart glasses), or any other communication device that a user may utilize to access the networked system 100. In some embodiments, the client device 110 comprises a display component (not shown) to display information (e.g., in the form of user interfaces). In further embodiments, the client device 110 comprises one or more of touch screens, accelerometers, gyroscopes, cameras, microphones, Global Positioning System (GPS) devices, and so forth. The client device 110 may be a device of a user that is used to request and receive reservation information, accommodation information, entry and access information for a reserved accommodation, set or update user preferences, request to view listings, view listings results in a list form or in a maps viewport, request for and connect with co-hosts, and so forth, associated with travel or other products or services. The client device 110 may also be a device of a user that is used to post and maintain a listing for a service, request and receive reservation information and guest information, generate entry and access information (e.g., access codes), set or update user preferences, and so forth.

One or more users 106 may be a person (e.g., guest, host, service personnel, customer support agent), a machine, or other means of interacting with the client device 110. In example embodiments, the user 106 may not be part of the networked system 100 but may interact with the networked system 100 via the client device 110 or other means. For instance, the user 106 can provide input (e.g., voice input, touch screen input, alphanumeric input) to the client device 110 and the input may be communicated to other entities in the networked system 100 (e.g., third-party servers 130, a server system 102) via a network 104. In this instance, the other entities in the networked system 100, in response to receiving the input from the user 106, can communicate information to the client device 110 via the network 104 to be presented to the user 106. In this way, the user 106 can interact with the various entities in the networked system 100 using the client device 110.

The networked system 100 further includes a network 104. One or more portions of the network 104 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the internet, a portion of the public switched telephone network (PSTN), a cellular telephone network, a wireless network, a Wi-Fi network, a WiMAX network, another type of network, or a combination of two or more such networks.

One or more portions of the network 104 can comprise short-range wireless communication, such as Bluetooth, WiFi, near field communication (NFC), ultraband, Zigbee, or other form of short-range wireless communication.

The client device 110 can access the various data and applications provided by other entities in the networked system 100 via a web client 112 (e.g., a browser, such as the Internet Explorer® browser developed by Microsoft® Corporation of Redmond, Washington) or one or more client applications 114. The client device 110 can include one or more client applications 114 (also referred to as “apps”) such as, but not limited to, a web browser, a messaging application, an electronic mail (email) application, an ecommerce site application, a mapping or location application, a reservation application, an entry or keypad access application, a customer support application, and the like.

In some embodiments, one or more client applications 114 can be included in a given one of the client devices 110 and configured to locally provide the user interface and at least some of the functionalities, with the client application 114 configured to communicate with other entities in the networked system 100 (e.g., third-party servers 130, the server system 102), on an as-needed basis, for data and/or processing capabilities not locally available (e.g., to access reservation or listing information, request data, authenticate a user 106, verify a method of payment, receive an access code). Conversely, one or more client applications 114 may not be included in the client device 110, and then the client device 110 can use its web browser to access the one or more applications hosted on other entities in the networked system 100 (e.g., third-party servers 130, the server system 102).

The networked system 100 can further include one or more third-party servers 130. The one or more third-party servers 130 may include one or more third-party application(s) 132. The one or more third-party application(s) 132, executing on the third-party server(s) 130, can interact with the server system 102 via a programmatic interface provided by an application programming interface (API) gateway server 120. For example, one or more of the third-party applications 132 can request and utilize information from the server system 102 via the API gateway server 120 to support one or more features or functions on a website hosted by a third party or an application hosted by the third party. The third-party website or application 132, for example, can provide various functionality that is supported by relevant functionality and data in the server system 102, such as entry and access information for an accommodation. The third-party servers 130 can be a cloud computing environment, according to some example embodiments. The third-party servers 130, and any servers associated with the third-party servers 130, can be associated with a cloud-based application, in one example embodiment.

The server system 102 can provide server-side functionality via the network 104 (e.g., the internet or a WAN) to one or more third-party servers 130 and/or one or more client devices 110 and/or one or more accommodation devices 140. The server system 102 is a cloud computing environment, according to some example embodiments. The server system 102, and any servers associated with the server system 102, are associated with a cloud-based application, in one example embodiment.

In one example, the server system 102 provides server-side functionality for an online marketplace. The online marketplace provides various listings for trip items, such as accommodations hosted by various managers (also referred to as “owners” or “hosts”) that can be reserved by clients (also referred to as “users” or “guests”), such as an apartment, a house, a cabin, one or more rooms in an apartment or house, and the like. The online marketplace can provide for methods for hosts to search for and connect with co-hosts to manage one or more listings in the online marketplace. As explained above, the online marketplace can further provide listings for other trip items, such as experiences (e.g., local tours), car rentals, flights, public transportation, and other transportation or activities related to travel.

The server system 102 can include the API gateway server 120, a web server 122, a reservation system 124 and a ranking optimization system 128 that can be communicatively coupled with one or more databases 126 or other forms of data store.

The one or more databases 126 can be one or more storage devices that store data related to the reservation system 124, the ranking optimization system 128, and other systems or data. The one or more databases 126 can further store information related to third-party servers 130, third-party applications 132, client devices 110, client applications 114, users 106, and so forth. The one or more databases 126 can be implemented using any suitable database management system such as MySQL, PostgreSQL, Microsoft SQL Server, Oracle, SAP, IBM DB2, or the like. The one or more databases 126 include cloud-based storage in some embodiments.

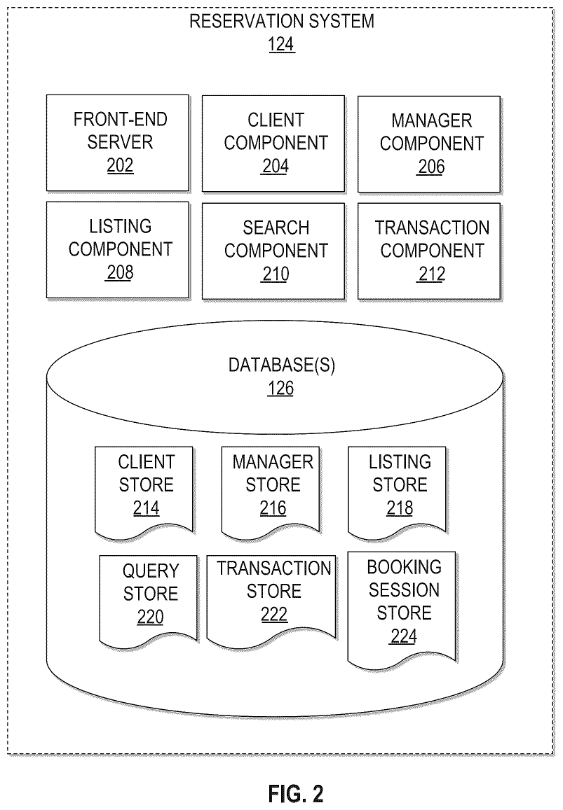

The reservation system 124 manages resources and provides back-end support for third-party servers 130, third-party applications 132, client applications 114, and so forth, which may include cloud-based applications. The reservation system 124 provides functionality for viewing listings related to trip items (e.g., accommodation listings, activity listings), generating and posting a new listing, analyzing and ranking images to be posted in a new listing, managing listings, booking listings and other reservation functionality, and so forth, for an online marketplace. Further details related to the reservation system 124 are shown in FIG. 2.

FIG. 2 is a block diagram illustrating a reservation system 124, according to some example embodiments. The reservation system 124 comprises a front-end server 202, a client component 204, a manager component 206, a listing component 208, a search component 210, and a transaction component 212. The one or more database(s) 126 include a client store 214, a manager store 216, a listing store 218, a query store 220, a transaction store 222, and a booking session store 224. The reservation system 124 may also contain different and/or other components that are not described herein.

The reservation system 124 can be implemented using a single computing device or a network of computing devices, including cloud-based computer implementations. The computing devices can be server-class computers including one or more high-performance computer processors and random access memory, which can run an operating system such as Linux or the like. The operations of the reservation system 124 can be controlled either through hardware or through computer programs installed in nontransitory computer-readable storage devices such as solid-state devices or magnetic storage devices and executed by the processors to perform the functions described herein.

The front-end server 202 includes program code that allows client devices 110 to communicate with the reservation system 124. The front-end server 202 can utilize the API gateway server 120 and/or the web server 122 shown in FIG. 1. The front-end server 202 can include a web server hosting one or more websites accessible via a hypertext transfer protocol (HTTP), such that user agents, such as a web browser software application, can be installed on the client devices 110 and can send commands to and receive data from the reservation system 124. The front-end server 202 can also utilize the API gateway server 120 that allows software applications installed on client devices 110 and third-party servers 130 and applications 132 to call to the API to send commands to and receive data from the reservation system 124. The front-end server 202 further includes program code to route commands and data to the other components of the reservation system 124 to carry out the processes described herein and respond to the client devices 110 accordingly.

The client component 204 comprises program code that allows clients (also referred to herein as “users” or “guests”) to manage their interactions with the reservation system 124 and executes processing logic for client-related information that may be requested by other components of the reservation system 124. Each client is represented in the reservation system 124 by an individual client object having a unique client identifier (ID) and client profile, both of which are stored in the client store 214.

The client profile includes a number of client-related attribute fields that can include a profile picture and/or other identifying information, a geographical location, a client calendar, an access code, smart device preferences (e.g., user preferences), and so forth. The client's geographical location is either the client's current location (e.g., based on information provided by the client device 110) or the client's manually entered home address, neighborhood, city, state, or country of residence. The client location may be used to filter search criteria for time-expiring inventory relevant to a particular client or to assign default language preferences.

The client component 204 comprises program code to provide for clients to set up and modify the client profile. The reservation system 124 allows each client to exchange communications, request transactions, and perform transactions with one or more managers.

The manager component 206 comprises program code that provides a user interface that allows managers (also referred to herein as “users,” “hosts,” “co-hosts” or “owners”) to manage their interactions and listings with the reservation system 124 and executes processing logic for manager-related information that may be requested by other components of the reservation system 124. Each manager is represented in the reservation system 124 by an individual manager object having a unique manager ID and manager profile, both of which are stored in the manager store 216.

The manager profile is associated with one or more listings owned or managed by the manager and includes a number of manager attributes including transaction requests and a set of listing calendars for each of the listings managed by the manager.

The manager component 206 provides code for managers to set up and modify the manager profile listings. A user 106 of the reservation system 124 can be both a manager and a client. In this case, the user 106 will have a profile entry in both the client store 214 and the manager store 216 and be represented by both a client object and a manager object. The reservation system 124 allows the manager to exchange communications, respond to requests for transactions, and conduct transactions with other managers.

The listing component 208 comprises program code for managers to list trip items, such as time-expiring inventory, for booking by clients. The listing component 208 is configured to receive the listing from a manager describing the inventory being offered; a timeframe of its availability including one or more of the start date, end date, start time, and an end time; a price; a geographical location; images and descriptions that characterize the inventory; and any other relevant information. For example, for an accommodation reservation system, a listing may include a type of accommodation (e.g., house, apartment, room, sleeping space, or other), a representation of its size (e.g., square footage, number of rooms), the dates that the accommodation is available, and a price (e.g., per night, per week, per month). The listing component 208 allows a user 106 to include additional information about the inventory, such as videos, photographs, and other media, or such as accessibility and other information.

The geographical location associated with the listing identifies the complete address, neighborhood, city, and/or country of the offered listing. The listing component 208 is also capable of converting one type of location information (e.g., mailing address) into another type of location information (e.g., country, state, city, neighborhood) using externally available geographical map information.

The price of the listing is the amount of money a client needs to pay in order to complete a transaction for the inventory. The price may be specified as an amount of money per day, per week, per month, and/or per season, or per another interval of time specified by the manager. Additionally, the price may include additional charges such as cleaning fees, pet fees, service fees, and taxes, or the listing price may be listed separately from additional charges.

Each listing is represented in the reservation system 124 by a listing object, which includes the listing information as provided by the manager and a unique listing ID, both of which are stored in the listing store 218. Each listing object is also associated with the manager object for the manager providing the listing.

Each listing object has an associated listing calendar. The listing calendar stores the availability of the listing for each time interval in a period (each of which may be thought of as an independent item of time-expiring inventory), as specified by the manager or determined automatically (e.g., through a calendar import process). For example, a manager may access the listing calendar for a listing, and manually indicate the time intervals for which the listing is available for transaction by a client, which time intervals are blocked as not available by the manager, and which time intervals are already in transaction (e.g., booked) for a client. In addition, the listing calendar continues to store historical information as to the availability of the listing identifying which past time intervals were booked by clients, blocked, or available. Further, the listing calendar may include calendar rules (e.g., the minimum and maximum number of nights allowed for the inventory, a minimum or maximum number of nights needed between bookings, a minimum or maximum number of people allowed for the inventory). Information from each listing calendar is stored in the listing store 218.

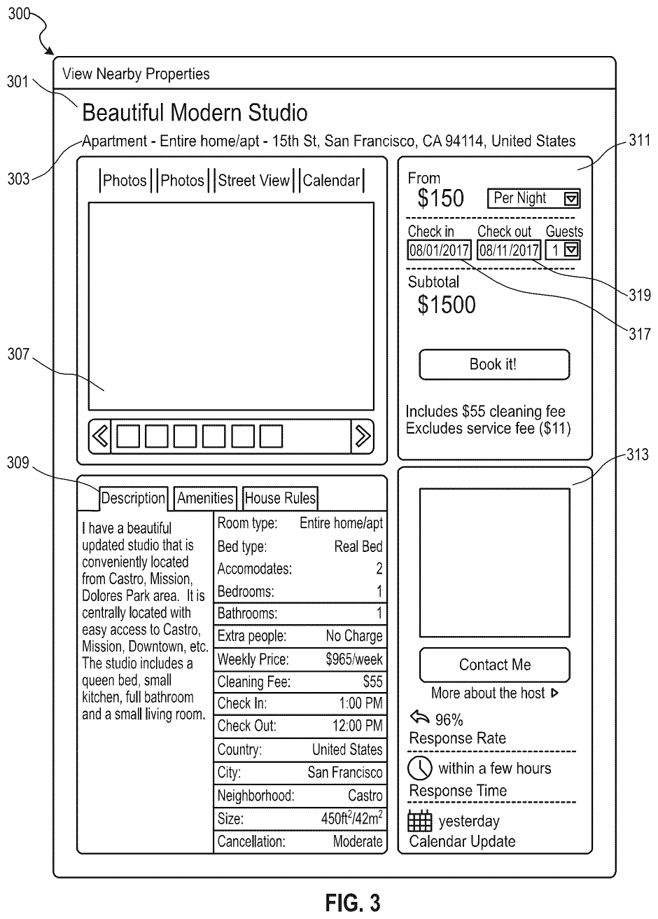

FIG. 3 illustrates an example user interface 300 for a description of a listing for a trip item (e.g., an apartment in San Francisco) in an online marketplace. The example listing shown in FIG. 3 is for accommodations in San Francisco. In other examples, the listing could be for a tour, local experience, transportation service, or other trip item. The listing may include a title 301 and a brief description 303 of the trip item. The listing may further include photos of the trip item, maps of the area or a location associated with the trip item, a street view of the trip item, a calendar for the trip item, and so forth, which may be viewed in area 307. The listing may include a detailed description 309, pricing information 311, and the listing host's information 313. The listing may further allow a user to select a date range for the trip item by entering or choosing specific check-in date 317 and check-out date 319.

Returning to FIG. 2, the search component 210 comprises program code configured to receive an input search query from a client and return a set of time-expiring inventory and/or listings that match the input query. Search queries are saved as query objects stored by the reservation system 124 in the query store 220. A query may contain a search location, a desired start time/date, a desired duration, a desired listing type, and a desired price range, and may also include other desired attributes or features of the listing. A potential client need not provide all the parameters of the query listed above in order to receive results from the search component 210. In some examples, the search component 210 provides a set of time-expiring inventory and/or listings in response to the submitted query to fulfill the parameters of the submitted query. The online system can also allow clients to browse listings without submitting a search query, in which case the viewing data recorded will only indicate that a client has viewed the particular listing without any further details from the submitted search query. Upon the client providing input selecting a time-expiring inventory/listing to more carefully review for possible transaction, the search component 210 records the selection/viewing data indicating which inventory/listing the client viewed. This information is also stored in the query store 220.

The search component 210 further comprises program code configured to receive an input request or search query from a client for one or more co-host to manage one or more listings in the online marketplace and return a set of ranked co-hosts relevant to the request, as described in further detail below.

The transaction component 212 comprises program code configured to enable clients to submit a contractual transaction request (also referred to as a formal request) to transact for time-expiring inventory. In operation, the transaction component 212 receives a transaction request from a client to transact for an item of time-expiring inventory, such as a particular date range for a listing offered by a particular manager. A transaction request may be a standardized request form that is sent by the client, which may be modified by responses to the request by the manager, either accepting or denying a received request form, such that agreeable terms are reached between the manager and the client. Modifications to a received request can include, for example, changing the date, price, or time/date range (and thus, effectively changing which time-expiring inventory is being transacted for). The standardized form may require the client to record the start time/date, duration (or end time), or any other details that must be included for an acceptance to be binding without further communication.

The transaction component 212 receives the filled-out form from the client and, in one example, presents the completed request form including the booking parameters to the manager associated with the listing. The manager may accept the request, reject the request, or provide a proposed alternative that modifies one or more of the parameters. If the manager accepts the request (or the client accepts the proposed alternative), then the transaction component 212 updates an acceptance status associated with the request and the time-expiring inventory to indicate that the request was accepted. The client calendar and the listing calendar are also updated to reflect that the time-expiring inventory has been transacted on for a particular time interval. Other components not specifically described herein allow the client to complete payment and the manager to receive payment.

The transaction component 212 may further comprise code configured to enable clients to instantly book a listing, whereby the online marketplace books or reserves the listing upon receipt of the filled-out form from the client.

The transaction store 222 stores requests made by clients. Each request is represented by a request object. The request includes a timestamp, a requested start time, and a requested duration or reservation end time. Because the acceptance of a booking by a manager is a contractually binding agreement with the client that the manager will provide the time-expiring inventory to the client at the specified times, all the information that the manager needs to approve such an agreement is included in the request. A manager response to a request comprises a value indicating acceptance or denial and a timestamp. Other models may allow for instant booking, as mentioned above.

The transaction component 212 may also provide managers and clients with the ability to exchange informal requests to transact. Informal requests are not sufficient to be binding upon the client or manager if accepted, and, in terms of content, may vary from mere communications and general inquiries regarding the availability of inventory, to requests that fall just short of whatever specific requirements the reservation system 124 sets forth for formal transaction requests. The transaction component 212 may also store informal requests in the transaction store 222, as both informal and formal requests provide useful information about the demand for time-expiring inventory.

The booking session store 224 stores booking session data for all booking sessions performed by clients. Booking session data may include details about a listing that was booked and data about one or more other listings that were viewed (or seriously considered) but not booked by the client before booking the listing. For example, once a listing is booked, the transaction component 212 may send data about the listing or the transaction, viewing data that was recorded for the booking session, and so forth, to be stored in the booking session store 224. The transaction component 212 may utilize other components or data stores to generate booking session data to be stored in the booking session store 224.

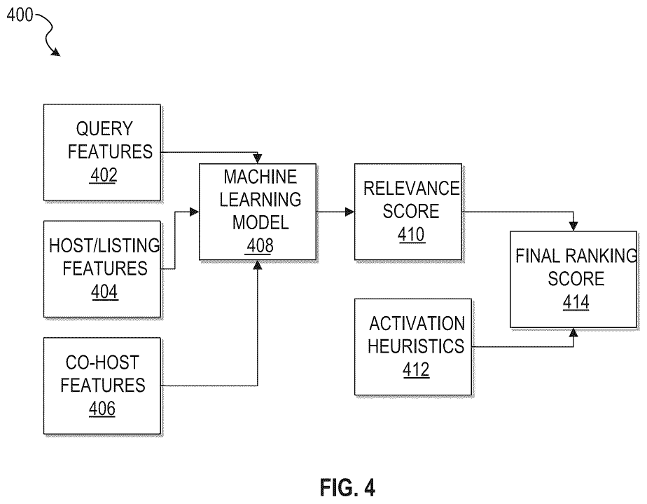

FIG. 4 is a block diagram 400 illustrating further details of the optimized ranking system 128. The optimized ranking system 128 utilizes query features 402 that are features entered in a request from a computing device of a host to search for a co-host. The query features can include a location for a co-host, such one or more of an address, city, zip code, or country. These features can be input by the host or these features can be determined based on an address associated with the host, an address of one or more listings associated with a host, a GPS signal sent by the computing device of the host (e.g., when the host chooses “use my location”), or other method.

The optimized ranking system 128 further utilizes host and listing features 404 that are related to characteristics and preferences of a host, such as host tenure, listing type, size of listing, number of bedrooms, and so forth. The optimized ranking system 128 also utilizes co-host features 406 related to a co-host performance and reputation, such as a proximity to a requesting host's listing, an average overall rating, services offered, and so forth.

The optimized ranking system 128 analyzes the features 402, 404 and 406 using a machine learning model 408. The machine learning model 408 outputs a relevance score 410 based on this analysis. The optimized ranking system 128 further generates activation heuristics 412 which are combined with the relevance score 410 to generate the final ranking score 414. In some examples, the optimized ranking system 128 divides the number of hosts activated by the number of hosts connected to generate the co-host activation rate for each co-host. The final ranking score 414 is used to rank candidate co-hosts from a highest to lowest score, in some embodiments. Further details of the optimized ranking system 128 is described next.

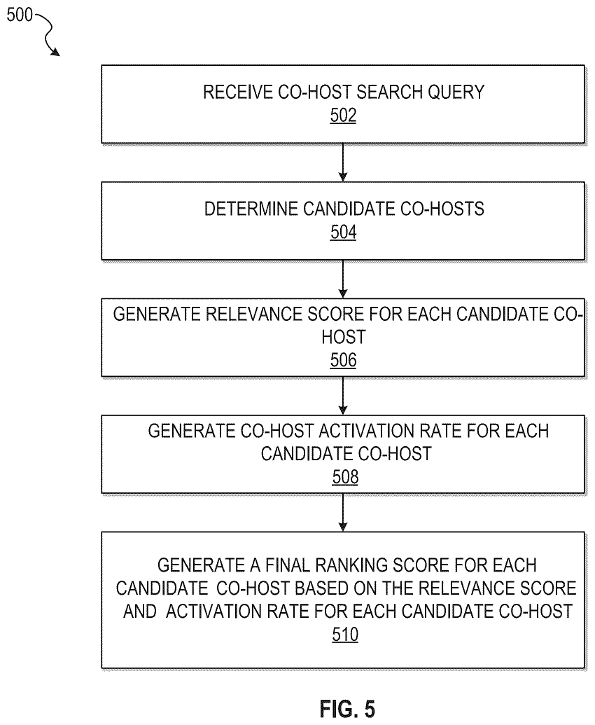

FIG. 5 is a flowchart illustrating aspects of a method 500 for optimized ranking, according to some example embodiments. For illustrative purposes, the method 500 is described with respect to the networked system 100 of FIG. 1. It is to be understood that the method 500 may be practiced with other system configurations in other embodiments.

In operation 502, a computing system (e.g., server system 102, reservation system 124, or optimized ranking system 128) receives, from a computing device, a co-host search query from a host of a listing in an online marketplace. For example, a user that is a host of one or more listings in an online marketplace submits, via the computing device, a request for a co-host to manage the one or more listings. The request, or co-host search query, can include a location for a co-host, such one or more of an address, city, zip code, or country. The location may be associated with the host's location, a location of the listing of the host, and the like. These features can be input by the host or these features can be determined based on an address associated with the host, an address of one or more listings associated with a host, a GPS signal sent by the computing device of the host, or other method. In one example, the host can be a potential host that does not yet have any listing in the online marketplace but is searching for a co-host to help with creating and/or managing a listing to be included in the online marketplace.

The computing system provides a response to the co-host search query, in real time or near real time, that includes a ranked list of candidate co-hosts based on a final ranking score for each of the candidate co-hosts by performing the operations 504-510. In operation 504, the computing system determines the candidate co-hosts from a plurality of co-hosts based on parameters in the co-host search query. In some examples, the candidate co-hosts are determined based on computing a proximity (e.g., distance) between a location in the search query and a location associated with each co-host. In other examples, the candidate co-hosts are determined based on a city indicated by the location in the search query and a city associated with each candidate co-host. For example, the candidate co-hosts would be co-hosts located or with services in the same or nearby location (e.g., city or other geographical area) as a location in the search query.

In operation 506, the computing system generates a relevance score for each candidate co-host. For example, the computing system, using a trained machine learning model configured to generate a relevance score for each of a plurality of candidate co-hosts, analyzes the search query, characteristics associated with the host, listing features for listings associated with the host, and co-host features associated with each candidate co-host to generate a relevance score for each candidate co-host. In one example, the machine learning model is a pairwise XGBoost learn-to-rank (LTR) model. It is to be understood that other types of models can be used in examples described herein. The relevance score can be a negative number or a positive number. Further, the features used to train the machine learning model and to generate the relevance score can change over time based on what features generate the best results for determining relevant co-hosts for a given host.

In some examples, characteristics of the host comprises one or more of a length of time the host has been a part of the online marketplace, how many listings the host has in the online marketplace, the size of one or more listings, amenities in one or more listings, number of bedrooms in one or more listings, an address of one or more listings, and so forth. In some examples, the co-host features for each candidate comprise one or more of how many listings the candidate co-host is managing, how long the candidate co-host has been co-hosting, what kinds of services are provided by the candidate co-host, service types provided by the co-host, ratings and reviews for the co-host, types of listings with which the co-host is associated, host engagement with a profile for the co-host, a co-host location, the co-host history in the online marketplace, what type of listings are associated with the co-host, the location of the listings associated with the co-host, and so forth.

In some examples, characteristics of a co-host are generated from a profile description provided by the co-host in the online marketplace. In some examples, the profile description is in an unstructured format. These characteristics can include services offered by a co-host and one or more persona types. For example, the computing system analyzes each co-host profile using a large language model (LLM), such as ChatGPT4, to extract types of services offered by a co-host and a persona corresponding to the co-host. Types of services offered can include cleaning, guest communication, handyman services, and so forth. The computing system uses the LLM to analyze the profile description in the online marketplace for the co-host to determine if the co-host provides any of a number of types of services. These services are characteristics of the co-host that are used to generate the relevance score as described above.

In some examples, a co-host profile includes predefined types of services where the co-host has provided specific details for relevant types of services. For example, a co-host can be prompted to input what type of services the co-host provides, with a description for each type of service. For instance, the co-host can select each type of service that the co-host provides, such as listing setup, setting prices and availability, booking request management, guest messaging, interior design and styling, and/or other services. For each selected type of service, the co-host can provide details about what the co-host provides for the type of service. These services are characteristics of the co-host that are used to generate the relevance score as described above.

A persona of a co-host can include a local expert, property manager, or other persona type also based on the profile description for a co-host. For example, the computing system uses the LLM to analyze the profile description in the online marketplace for the co-host to determine if the co-host corresponds to any of a number of types of personas. These personas are characteristics of the co-host that are used to generate the relevance score as described above.

In some examples, the computing system, using the above-mentioned trained machine learning model, further analyzes a proximity between a location in the search query and a location associated with each candidate co-host. For example, the computing system computes a proximity between a location in the search query and a location associated with each candidate co-host and then analyzes the computed proximity for each candidate co-host in addition to the other features mentioned above to generate a relevance score for each candidate co-host.

In operation 508, the computing system generates a co-host activation rate for each candidate co-host. The co-host activation rate is generated based on a number of hosts each candidate co-host has connected with and a number of hosts each candidate co-host has activated. For instance, the computing system generates the co-host activation rate for each candidate by dividing the number of hosts each candidate co-host has activated by the number of hosts each candidate has connected with to generate the co-host activation rate. In some examples, the hosts to which the candidate co-host are connected or activated are those that are activated/connected within a predefined time period (e.g., 6 months, 365 days). In this way, the optimization ranking system 128 can prioritize co-hosts that have previously activated partnerships with hosts.

In some examples, the computing system generates, for each co-host candidate, a normalized relevance score for the respective relevance score using a normalization function. For example, the computing system normalizes the relevance score to fall into a range from 0 to 1 using a normalization function, such as MinMaxScaler( ) or other method, for normalization to preserve the original distribution of scores. In this way, the computing system uses a normalization function, such as a MinMaxScaler( ) or other technique, that generates a normalized relevance score between 0 and 1.

Further, in order to generate a final ranking score, the computing system converts the activation rate to a probability-like value that follows a Sigmoid curve. In this way, the computing system generates, for each co-host candidate, an activation probability based on the activation rate for each co-host candidate. This activation probability is also referred to below as “Sigmoid Activation Probability.”

In operation 510, the computing system generates a final ranking score for each co-host candidate based on the normalized relevance score and the activation probability for each co-host candidate. In some examples, the computing system generates the final ranking score by multiplying the normalized relevance score and the activation probability for each co-host candidate to generate the final ranking score for each candidate. This can be denoted as follows:

“Final” Ranking Score=Normalized Relevance Score*Sigmoid Activation Probability

In this way the final ranking score can capture interactions between relevance score and activation rate and reflect the idea that both values should contribute positively for an overall final positive outcome. A higher final ranking score corresponds to a better ranking (e.g., a co-host that is more relevant to the given host). This ranking process ensures that the more relevant co-hosts with higher activation rate are prioritized for a given host.

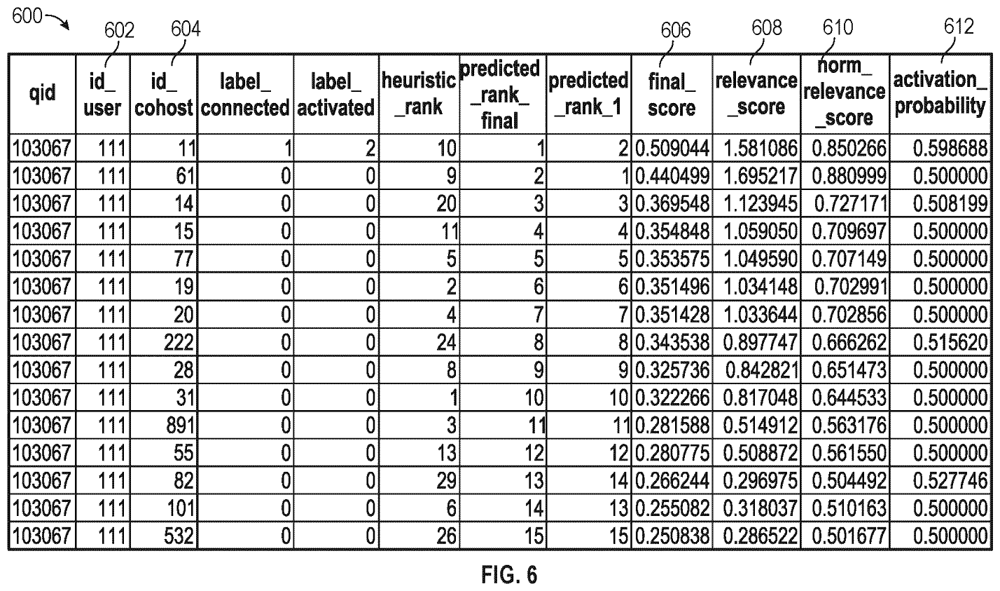

FIG. 6 is an example table 600 illustrating a list of candidate co-hosts (represented by id_cohost 604) for a given host (id_user 602). The final_score 606 is the final ranking score based on the normalized relevance score (norm_relevance_score 610) and activation probability (activation_probablitity 612). The relevance_score 608 in FIG. 6 is the relevance score before it is normalized.

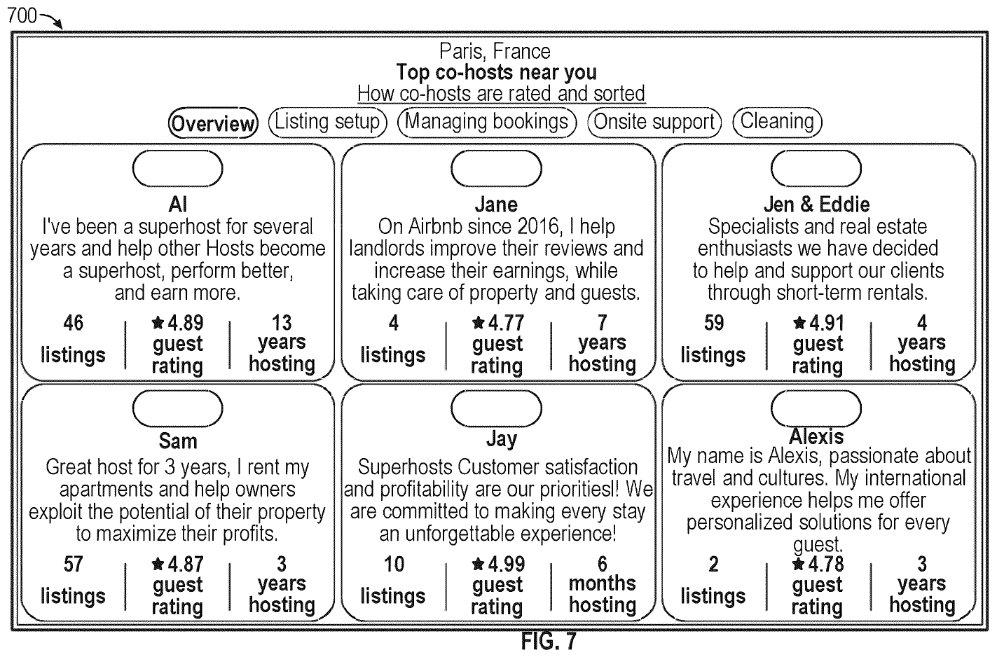

In some examples, the ranked list of the candidate co-hosts is displayed on a user interface of the computing device in an order based on the final ranking score for each of the candidate co-hosts. FIG. 7 illustrates an example user interface 700 displaying a ranked list of candidate co-hosts. The example user interface 700 includes a photo of each co-host, the co-host name(s), a number of listings, guest ratings, years hosting and a description. It is to be understood that other features or different features can be included in a user interface displaying a ranked list of candidate co-hosts.

In some examples, the trained machine learning model 408 can be retrained based on engagement signals such as how many times the co-host profile (or new UI components) is viewed or clicked by the user, the click-through-rate of the co-host profile (or new UI components), and so forth. These signals are helpful to understand a user's intent and interests and thus can be used to update and improve the trained machine learning model 408 accordingly.

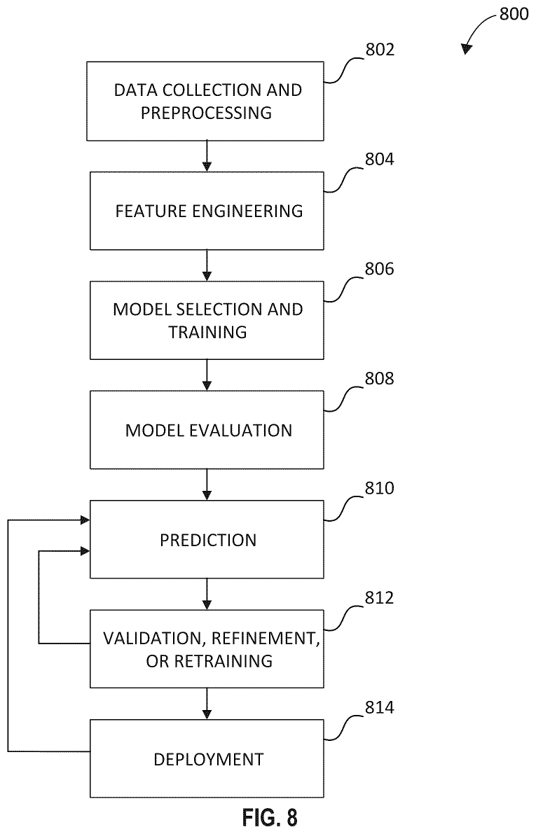

FIG. 8 is a flowchart depicting a machine learning pipeline 800, according to some examples. The machine learning pipeline 800 may be used to generate a trained model, for example, the trained machine learning model 408 shown in the diagram 400 of FIG. 4.

Broadly, machine learning can involve using computer algorithms to automatically learn patterns and relationships in data, potentially without the need for explicit programming. Machine learning algorithms include three categories: supervised learning, unsupervised learning, and reinforcement learning.
Supervised learning involves training a model using labeled data to predict an output for new, unseen inputs. Examples of supervised learning algorithms may include linear regression, decision trees, and neural networks.
Unsupervised learning involves training a model on unlabeled data to find hidden patterns and relationships in the data. Examples of unsupervised learning algorithms may include clustering, principal component analysis, and certain generative models, such as autoencoders.
Reinforcement learning involves training a model to make decisions in a dynamic environment by receiving feedback in the form of rewards or penalties.
Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is a supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other machine learning algorithms may include decision trees, k-nearest neighbors, clustering algorithms, and deep learning algorithms, such as Convolutional Neural Networks (CNNs), recurrent neural networks (RNNs), and transformer models. The choice of algorithm may depend on various factors, such as the nature of the data, the complexity of the problem, and the performance requirements of the application. The performance of machine learning models may be evaluated on a separate test set of data that was not used during training to ensure that the model can generalize to new, unseen data.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine learning model 408 may include multiple phases that form part of the machine learning pipeline 800, including, for example, the following phases illustrated in FIG. 8. One phase includes data collection and preprocessing 802. This phase may include acquiring and cleaning data to ensure that it is suitable for use in the machine learning model. This phase may also include removing duplicates, handling missing values, and converting data into a suitable format.

For example, data is extracted from one or more databases 126 of an online marketplace that include data from queries input by a host for a co-host (query features 402), host and listing features 404, and co-host features 406. These features are explained in further detail above.

In some examples, the data can be preprocessed using filters and downsampling to select a representative data set from the extracted data to be used for training data to train the machine learning model 408. For example, events can be deduplicated by filtering out duplicate events that have the exact same query search and results for a given host on a given day. This is to reduce the number of redundant information. The extracted data can further exclude events that contain only one co-host in the search result because there is no need to rank this outcome and the goal is for the machine learning model to learn meaningful patterns.

As another preprocessing example, known spamming hosts can be excluded so that these types of hosts, such as hosts that contact more than a predefined number of co-hosts (e.g., 25, 30, 50) are filtered out. Further, in areas that have a large number of co-hosts, the number of co-hosts can be capped to a predefined number (e.g., 25, 40, 60) in the training data set to reduce the number of negative instances.

As another example, the training dataset can be downsampled to allow the machine learning model 408 to learn more about positive instances.

Further, this extracted data can be labeled directly using factual data where data is labeled 1 if a host is connected with a co-host and is otherwise labeled 0. In some examples, several million rows of data are used within a predefined time period, such as a 6-month, 9-month, 12-month or other time range.

The data resulting after any preprocessing is the training data used to train a model to generate the trained machine learning model 408.

Another phase illustrated in FIG. 8 is feature engineering 804. This phase can include selecting and transforming the training data to create features that are useful for predicting the target variable. Feature engineering may include (1) receiving features (e.g., as structured or labeled data in supervised learning) and/or (2) identifying features (e.g., unstructured or unlabeled data for unsupervised learning) in training data.

Another phase illustrated in FIG. 8 is model selection and training 806. This phase can include selecting an appropriate machine learning algorithm and training it on the preprocessed data. This phase may further involve splitting the data into training and testing sets, using cross-validation to evaluate the model, and tuning hyperparameters to improve performance.

The model evaluation 808 phase can include evaluating the performance of a trained model (e.g., the trained machine learning model 408) on a separate testing dataset. This phase can help determine if the model is overfitting or underfitting and determine whether the model is suitable for deployment.

The prediction 810 phase involves using a trained model (e.g., trained machine learning model 408) to generate predictions on new, unseen data. The validation, refinement or retraining 812 phase can include updating a model based on feedback generated from the prediction phase, such as new data or user feedback.

The deployment 814 phase can include integrating the trained model (e.g., the trained machine learning model 408) into a more extensive system or application, such as a web service, mobile app, or Internet of Things (IoT) device.

This phase can involve setting up APIs, building a user interface, and ensuring that the model is scalable and can handle sufficiently large volumes of data. In some examples, adjustment can be performed prior to deployment 814. For example, the trained machine learning model 408 can be processed based on an adjustment protocol as described elsewhere herein.

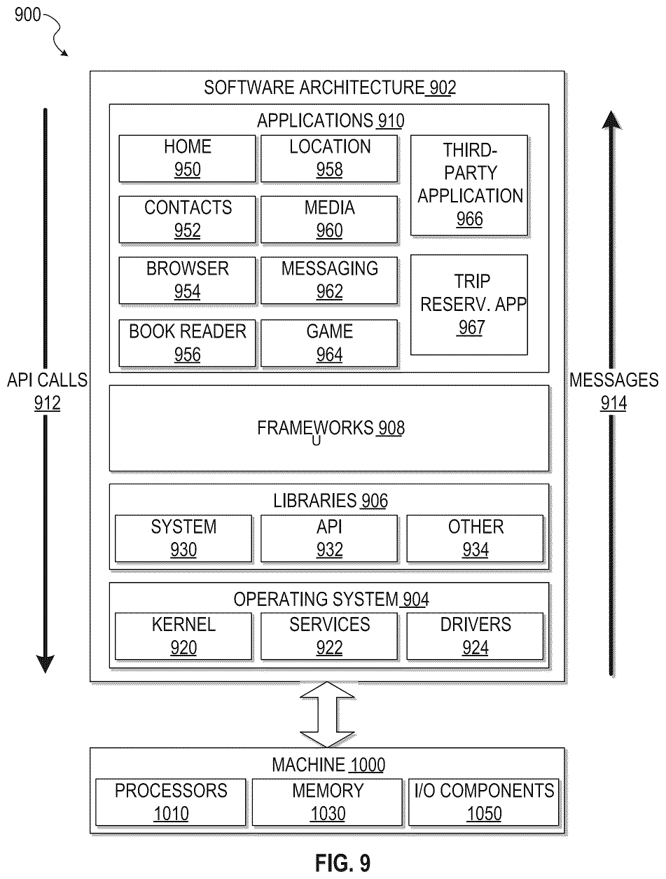

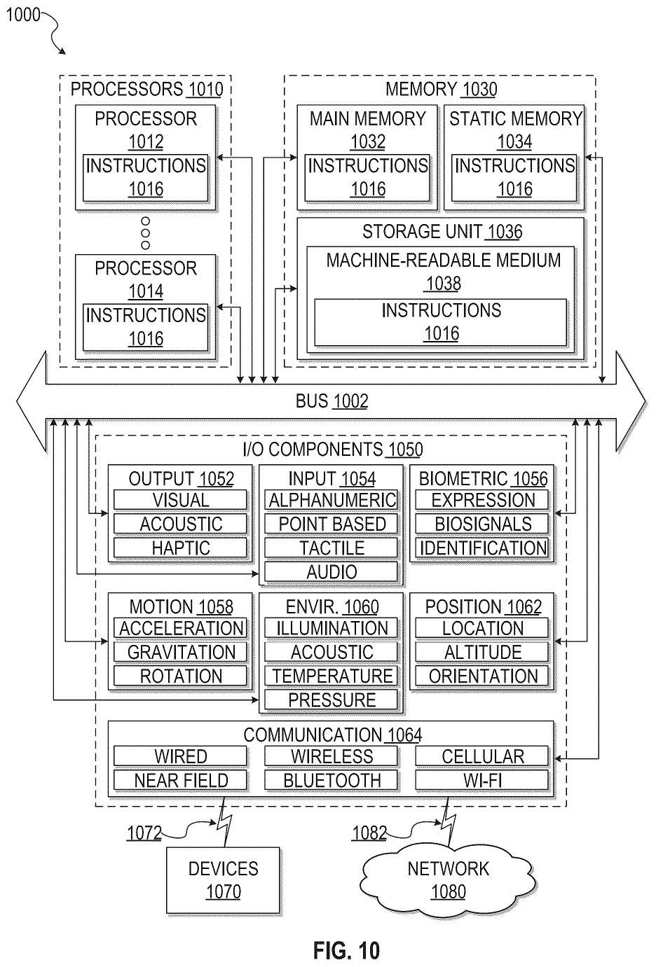

FIG. 9 is a block diagram 900 illustrating a software architecture 902, which can be installed on any one or more of the devices described above. For example, in various embodiments, the client device 110 and server systems 130, 102, 120, 122, and 124 may be implemented using some or all of the elements of the software architecture 902. FIG. 9 is merely a nonlimiting example of a software architecture, and it will be appreciated that many other architectures can be implemented to facilitate the functionality described herein. In various embodiments, the software architecture 902 is implemented by hardware such as a machine 1000 of FIG. 10 that includes processors 1010, memory 1030, and input/output (I/O) components 1050. In this example, the software architecture 902 can be conceptualized as a stack of layers where each layer may provide a particular functionality. For example, the software architecture 1002 includes layers such as an operating system 904, libraries 906, frameworks 908, and applications 910. Operationally, the applications 910 invoke API calls 912 through the software stack and receive messages 914 in response to the API calls 912, consistent with some embodiments.

In various implementations, the operating system 904 manages hardware resources and provides common services. The operating system 904 includes, for example, a kernel 920, services 922, and drivers 924. The kernel 920 acts as an abstraction layer between the hardware and the other software layers, consistent with some embodiments. For example, the kernel 920 provides memory management, processor management (e.g., scheduling), component management, networking, and security settings, among other functionalities. The services 922 can provide other common services for the other software layers. The drivers 924 are responsible for controlling or interfacing with the underlying hardware, according to some embodiments. For instance, the drivers 924 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematic functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render graphic content in two dimensions (2D) and in three dimensions (3D) on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various graphic user interface (GUI) functions, high-level resource management, high-level location services, and so forth. The frameworks 908 can provide a broad spectrum of other APIs that can be utilized by the applications 910, some of which may be specific to a particular operating system 904 or platform.

In an example embodiment, the applications 910 include a home application 950, a contacts application 952, a browser application 954, a book reader application 956, a location application 958, a media application 960, a messaging application 962, a game application 964, and a broad assortment of other applications, such as a third-party application 966. According to some embodiments, the applications 910 are programs that execute functions defined in the programs. Various programming languages can be employed to create one or more of the applications 910, structured in a variety of manners, such as object-oriented programming languages (e.g., Objective-C, Java, C++) or procedural programming languages (e.g., C or assembly language). In a specific example, the third-party application 966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 966 can invoke the API calls 912 provided by the operating system 904 to facilitate functionality described herein.

Some embodiments may particularly include a trip reservation application 967, which may be any application that requests data or other tasks to be performed by systems and servers described herein, such as the server system 102, third-party servers 130, and so forth. In certain embodiments, this may be a standalone application that operates to manage communications with a server system such as the third-party servers 130 or server system 102. In other embodiments, this functionality may be integrated with another application. The trip reservation application 967 may request and display various data related to an online marketplace and may provide the capability for a user 106 to input data related to the system via voice, a touch interface, or a keyboard, or using a camera device of the machine 900, communication with a server system via the I/O components 950, and receipt and storage of object data in the memory 930. Presentation of information and user inputs associated with the information may be managed by the trip reservation application 967 using different frameworks 908, library 906 elements, or operating system 904 elements operating on a machine 900.

FIG. 10 is a block diagram illustrating components of a machine 1000, according to some embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application 1010, an applet, an app, or other executable code) for causing the machine 1000 to perform any one or more of the methodologies discussed herein can be executed. In alternative embodiments, the machine 1000 operates as a standalone device or can be coupled (e.g., networked) to other machines. In a networked deployment, the machine 1000 may operate in the capacity of a server system 130, 102, 120, 122, 124, and the like, or a client device 110 in a server-client network environment, or as a peer machine in a peer-to-peer (or distributed) network environment. The machine 1000 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

In various embodiments, the machine 1000 comprises processors 1010, memory 1030, and I/O components 1050, which can be configured to communicate with each other via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) include, for example, a processor 1012 and a processor 1014 that may execute the instructions 1016. The term “processor” is intended to include multi-core processors 1010 that may comprise two or more independent processors 1012, 1014 (also referred to as “cores”) that can execute instructions 1016 contemporaneously. Although FIG. 10 shows multiple processors 1010, the machine 1000 may include a single processor 1010 with a single core, a single processor 1010 with multiple cores (e.g., a multi-core processor 1010), multiple processors 1012, 1014 with a single core, multiple processors 1012, 1014 with multiple cores, or any combination thereof.

The memory 1030 comprises a main memory 1032, a static memory 1034, and a storage unit 1036 accessible to the processors 1010 via the bus 1002, according to some embodiments. The storage unit 1036 can include a machine-readable medium 1038 on which are stored the instructions 1016 embodying any one or more of the methodologies or functions described herein. The instructions 1016 can also reside, completely or at least partially, within the main memory 1032, within the static memory 1034, within at least one of the processors 1010 (e.g., within the processor's cache memory), or any suitable combination thereof, during execution thereof by the machine 1000. Accordingly, in various embodiments, the main memory 1032, the static memory 1034, and the processors 1010 are considered machine-readable media 1038.

As used herein, the term “memory” refers to a machine-readable medium 1038 able to store data temporarily or permanently and may be taken to include, but not be limited to, random-access memory (RAM), read-only memory (ROM), buffer memory, flash memory, and cache memory. While the machine-readable medium 1038 is shown, in an example embodiment, to be a single medium, the term “machine-readable medium” should be taken to include a single medium or multiple media (e.g., a centralized or distributed database, or associated caches and servers) able to store the instructions 1016. The term “machine-readable medium” shall also be taken to include any medium, or combination of multiple media, that is capable of storing instructions (e.g., instructions 1016) for execution by a machine (e.g., machine 1000), such that the instructions 1016, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other nonvolatile memory (e.g., erasable programmable read-only memory (EPROM)), or any suitable combination thereof. The term “machine-readable medium” specifically excludes nonstatutory signals per se.

The I/O components 1050 include a wide variety of components to receive input, provide output, produce output, transmit information, exchange information, capture measurements, and so on. In general, it will be appreciated that the I/O components 1050 can include many other components that are not shown in FIG. 10. The I/O components 1050 are grouped according to functionality merely for simplifying the following discussion, and the grouping is in no way limiting. In various example embodiments, the I/O components 1050 include output components 1052 and input components 1054. The output components 1052 include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1054 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 1050 include biometric components 1056, motion components 1058, environmental components 1060, or position components 1062, among a wide array of other components. For example, the biometric components 1056 include components to detect expressions (e.g., hand expressions, facial expressions, vocal expressions, body gestures, eye tracking), measure biosignals (e.g., blood pressure, heart rate, body temperature, perspiration, brain waves), identify a person (e.g., voice identification, retinal identification, facial identification, fingerprint identification, electroencephalogram-based identification), and the like. The motion components 1058 include acceleration sensor components (e.g., accelerometer), gravitation sensor components, rotation sensor components (e.g., gyroscope), and so forth. The environmental components 1060 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1062 include location sensor components (e.g., a GPS receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 include a network interface component or another suitable device to interface with the network 1080. In further examples, communication components 1064 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 1070 may be another machine 1000 or any of a wide variety of peripheral devices (e.g., a peripheral device coupled via a USB).

Moreover, in some embodiments, the communication components 1064 detect identifiers or include components operable to detect identifiers. For example, the communication components 1064 include radio frequency identification (RFID) tag reader components, NFC smart tag detection components, optical reader components (e.g., an optical sensor to detect one-dimensional bar codes such as a Universal Product Code (UPC) bar code, multidimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1064, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 1080 can be an ad hoc network, an intranet, an extranet, a VPN, a LAN, a WLAN, a WAN, a WWAN, a MAN, the internet, a portion of the internet, a portion of the PSTN, a plain old telephone service (POTS) network, a cellular telephone network, a wireless network, a WI-FI® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile (GSM) communications connection, or another type of cellular or wireless coupling. In this example, the coupling 1082 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

In example embodiments, the instructions 1016 are transmitted or received over the network 1080 using a transmission medium via a network interface device (e.g., a network interface component included in the communication components 1064) and utilizing any one of a number of well-known transfer protocols (e.g., HTTP). Similarly, in other example embodiments, the instructions 1016 are transmitted or received using a transmission medium via the coupling 1072 (e.g., peer-to-peer coupling) to the devices 1070. The term “transmission medium” shall be taken to include any intangible medium that is capable of storing, encoding, or carrying the instructions 1016 for execution by the machine 1000, and includes digital or analog communications signals or other intangible media to facilitate communication of such software.

Furthermore, the machine-readable medium 1038 is nontransitory (in other words, not having any transitory signals) in that it does not embody a propagating signal. However, labeling the machine-readable medium 1038 “nontransitory” should not be construed to mean that the medium is incapable of movement; the machine-readable medium 1038 should be considered as being transportable from one physical location to another. Additionally, since the machine-readable medium 1038 is tangible, the machine-readable medium 1038 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, components, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method, comprising:
receiving, from a computing device, a co-host search query from a host or potential host of a listing in an online marketplace; and
providing, in real time, a ranked list of candidate co-hosts to the computing device based on a final ranking score for each candidate co-host, by performing operations comprising:
determining candidate co-hosts from a plurality of co-hosts based on parameters in the co-host search query;
using a trained machine learning model configured to generate a relevance score for each of a plurality of candidate co-hosts, analyzing the co-host search query, characteristics associated with the host, listing features for listings associated with the host, and co-host features associated with each candidate co-host to generate a relevance score for each candidate co-host;
generating a co-host activation rate for each candidate co-host based on a number of hosts each candidate co-host has connected with and a number of hosts each candidate co-host has activated;
generating, for each co-host candidate, a normalized relevance score for a respective relevance score using a normalization function;
generating, for each co-host candidate, an activation probability based on the co-host activation rate for each co-host candidate; and
generating a final ranking score for each co-host candidate based on the normalized relevance score and the activation probability for each co-host candidate.

2. The computer-implemented method of claim 1, wherein the candidate co-hosts are determined based on computing a proximity between a location in the co-host search query and a location associated with each candidate co-host.

3. The computer-implemented method of claim 1, further comprising:
computing a proximity between a location in the co-host search query and a location associated with each candidate co-host; and
wherein analyzing, using the trained machine learning model configured to generate a relevance score for a candidate co-host further comprises analyzing the computed proximity for each candidate co-host.

4. The computer-implemented method of claim 1, wherein a ranked list of the candidate co-hosts is displayed on a user interface of the computing device in an order based on the final ranking score for each candidate co-host.

5. The computer-implemented method of claim 1, wherein generating the co-host activation rate for each candidate comprises dividing the number of hosts each candidate co-host has activated by the number of hosts each candidate has connected with to generate the co-host activation rate.

6. The computer-implemented method of claim 1, wherein the normalization function is a MinMaxScaler( ) that generates a normalized relevance score between 0 and 1.

7. The computer-implemented method of claim 1, wherein generating the final ranking score comprises multiplying the normalized relevance score and the activation probability for each co-host candidate to generate the final ranking score for each candidate.

8. The computer-implemented method of claim 1, wherein the characteristics of the host comprises one or more of a length of time the host has been a part of the online marketplace, how many listings the host has in the online marketplace, size of one or more listings, amenities in one or more listings, number of bedrooms in one or more listings.

9. The computer-implemented method of claim 1, wherein the co-host features for each candidate co-host comprise one or more of how many listings the candidate co-host is managing, how long the candidate co-host has been co-hosting, or what types of services are provided by the candidate co-host.

10. The computer-implemented method of claim 1, analyzing, using a machine learning model, each co-host profile description for each candidate co-host to generate a list of types of services provided by each candidate co-host and wherein analyzing, using the trained machine learning model configured to generate a relevance score for a candidate co-host further comprises analyzing the generated list of types of services provided by each candidate co-host.

11. A computing system comprising:
a memory that stores instructions; and
one or more processors configured by the instructions to perform operations comprising:
receiving, from a computing device, a co-host search query from a host or a potential host of a listing in an online marketplace; and
providing, in real time, a ranked list of candidate co-hosts to the computing device based on a final ranking score for each candidate co-host, by performing operations comprising:
determining candidate co-hosts from a plurality of co-hosts based on parameters in the co-host search query;
using a trained machine learning model configured to generate a relevance score for each of a plurality of candidate co-hosts, analyzing the co-host search query, characteristics associated with the host, listing features for listings associated with the host, and co-host features associated with each candidate co-host to generate a relevance score for each candidate co-host;
generating a co-host activation rate for each candidate co-host based on a number of hosts each candidate co-host has connected with and a number of hosts each candidate co-host has activated;
generating, for each co-host candidate, a normalized relevance score for a respective relevance score using a normalization function;
generating, for each co-host candidate, an activation probability based on the co-host activation rate for each co-host candidate; and
generating a final ranking score for each co-host candidate based on the normalized relevance score and the activation probability for each co-host candidate.

12. The computing system of claim 11, wherein the candidate co-hosts are determined based on computing a proximity between a location in the co-host search query and a location associated with each candidate co-host.

13. The computing system of claim 11, the operations further comprising:
computing a proximity between a location in the co-host search query and a location associated with each candidate co-host; and
wherein analyzing, using the trained machine learning model configured to generate a relevance score for a candidate co-host further comprises analyzing the computed proximity for each candidate co-host.

14. The computing system of claim 11, wherein a ranked list of the candidate co-hosts is displayed on a user interface of the computing device in an order based on the final ranking score for each candidate co-host.

15. The computing system of claim 11, wherein generating the co-host activation rate for each candidate comprises dividing the number of hosts each candidate co-host has activated by the number of hosts each candidate has connected with to generate the co-host activation rate.

16. The computing system of claim 11, wherein the normalization function is a MinMaxScaler( ) that generates a normalized relevance score between 0 and 1.

17. The computing system of claim 11, wherein generating the final ranking score comprises multiplying the normalized relevance score and the activation probability for each co-host candidate to generate the final ranking score for each candidate.

18. The computing system of claim 11, wherein the characteristics of the host comprises one or more of a length of time the host has been a part of the online marketplace, how many listings the host has in the online marketplace, size of one or more listings, amenities in one or more listings, number of bedrooms in one or more listings and wherein the co-host features for each candidate co-host comprise one or more of how many listings the candidate co-host is managing, how long the candidate co-host has been co-hosting, or what types of services are provided by the candidate co-host.

19. The computer-implemented method of claim 1, analyzing, using a machine learning model, each co-host profile description for each candidate co-host to generate a list of types of services provided by each candidate co-host and wherein analyzing, using the trained machine learning model configured to generate a relevance score for a candidate co-host further comprises analyzing the generated list of types of services provided by each candidate co-host.

20. A non-transitory computer-readable medium comprising instructions stored thereon that are executable by at least one processor to cause a computing device to perform operations comprising:
receiving, from a computing device, a co-host search query from a host or a potential host of a listing in an online marketplace; and
providing, in real time, a ranked list of candidate co-hosts to the computing device based on a final ranking score for each candidate co-host, by performing operations comprising:
determining candidate co-hosts from a plurality of co-hosts based on parameters in the co-host search query;
using a trained machine learning model configured to generate a relevance score for each of a plurality of candidate co-hosts, analyzing the co-host search query, characteristics associated with the host, listing features for listings associated with the host, and co-host features associated with each candidate co-host to generate a relevance score for each candidate co-host;
generating a co-host activation rate for each candidate co-host based on a number of hosts each candidate co-host has connected with and a number of hosts each candidate co-host has activated;
generating, for each co-host candidate, a normalized relevance score for a respective relevance score using a normalization function;
generating, for each co-host candidate, an activation probability based on the co-host activation rate for each co-host candidate; and
generating a final ranking score for each co-host candidate based on the normalized relevance score and the activation probability for each co-host candidate.
